(19) United States
(12) Patent Application Publication
(10) Pub. No.: US 2026/0161926 A1
(43) Pub. Date: Jun. 11, 2026

(54) QUANTITATIVE ANALYSIS TOOL FOR INFERENCE SPEED AND PERFORMANCE OF ARTIFICIAL INTELLIGENCE MODELS

(71) Applicant: PAYPAL, INC., San Jose, CA (US)

(72) Inventors: Chi Liu, Shanghai (CN); Xiaoyi Shu, Shanghai (CN); Xin Chen, Shanghai (CN)

(21) Appl. No.: 18/970,146

(22) Filed: Dec. 5, 2024

(51) Int. Cl. G06N 3/0455

(52) U.S. Cl. CPC G06N 3/0455

(57) ABSTRACT

There are provided systems and methods for a quantitative analysis tool for inference speed and performance of AI models. An online transaction processor or other service provider may provide computing services and platforms to entities, which may include services that utilize AI models including LLMs. To provide more efficient training and testing of AI models, a service provider may utilize a quantitative analysis tool that executes operations for algorithmic techniques utilized to calculate model throughput parameters include prefill latency, decoding latency, and other performance metrics. For LLMs, these metrics may be used to compute a time-to-first-token, which may be used to assess an inferencing speed. The tool may analyze the performance metrics and model throughput parameters using model configurations and hardware specifications and may do so without real testing so that system resource usage may be reduced, and performance may be more quickly assessed.

### TECHNICAL FIELD

The present disclosure relates generally to artificial intelligence (AI) and machine learning (ML) systems and models, and more specifically to analyzing and configuring AI systems for AI model optimizations without time consuming and resource intensive performance testing.

### BACKGROUND

LLMs are widely used in enterprise applications due to their generalized natural language processing (NLP) capabilities. For example, service providers may have large computing systems and services that use LLMs and provide applications, websites, resources, and other computing services, including automated chatbots and other automated processes, with different end users, such as customers, clients, internal users and teams, and the like. Users may interact with various computing services that provide intelligent and automated responses and interactions based on the LLMs, neural networks (NNs), and other ML models. AI systems and models, such as different ML models including LLMs and other generative AI models, may be used to power emerging AI applications including video understanding and project-level coding.

However, the proliferation of LLMs and other types of ML models across various domains has led to increasingly large usage, which requires different LLMs and many processing systems (e.g., graphics processing units (GPUs)) to facilitate their execution. As such, current testing and deployment systems face costly and time-consuming tasks to benchmark the inference performance of LLMs on different GPUs and other processing units. Live performance testing, even in testing environments, involves significant manpower and GPU or other processing unit resource costs, which is problematic as it increases operational usage of valuable system resources and causes delays when providing time sensitive performance metrics to users, such as system analysts and engineers. It is therefore desirable to reduce the cost of testing, benchmarking, and deploying artificial intelligence (AI) and machine learning (ML) systems and models so that inference speeds and performance may be determined in a more efficient and faster manner, while retaining a high degree of accuracy. As such, there exists a need for a quantitative, automated, and programmatic process for testing performance of LLMs and other AI models when executed by different processing platforms for units for throughput metrics without requiring live and/or real testing that requires processing resource usage.

### BRIEF DESCRIPTION OF THE DRAWINGS

FIGS. 1A and 1B are block diagrams of networked systems suitable for implementing the processes described herein, according to an embodiment;

FIG. 2 is an exemplary computing architecture of a service provider that provides a quantitative analysis tool of AI models for inference speed and performance, according to an embodiment;

FIGS. 3A-3D are exemplary diagrams of AI model throughputs as tested by a quantitative analysis tool, according to various embodiments;

FIG. 4 is an exemplary user interface provided by a quantitative analysis tool for testing AI model inference speed and performance, according to various embodiments;

FIG. 5 is a flowchart for a quantitative analysis tool for inference speed and performance of AI models, according to an embodiment; and

FIG. 6 is a block diagram of a computer system suitable for implementing one or more components in FIG. 1A, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods for a quantitative analysis tool for inference speed and performance of AI models. Systems suitable for practicing methods of the present disclosure are also provided.

A service provider, such as an online transaction processor, may provide computing services to users and/or their corresponding entities, which may include end users and customers, merchant customers of an online transaction processor, businesses and their representatives and/or employees, and the like. These computing services may include those associated with electronic transaction processing, payments, digital account usage, peer-to-peer transfers and payments, and the like. With these computing services, intelligent search, question-and-answer systems, conversational AIs, and/or automated help or assistance may be provided via different platform communication channels, such as a website, application, email, digital alert, text message, push notification, instant message, or the like.

These search features, conversational AIs, chatbots, and other automated computing processes may allow end users of a service provider to utilize natural language to converse with automated systems for the service provider, which may utilize ML models, such as LLMs and other generative AIs. For example, an LLM may be used to respond to users in a conversational manner and/or provide natural language-based search, conversation, data generation, information retrieval, and other features. An online transaction processor may utilize LLMs with automated systems for account setup, authentication, account usage (e.g., during electronic transaction processing), mobile device or application usage, payment processing, and the like. Different service providers may also provide other intelligent and/or AI systems that may utilize other AI models, such as risk and fraud detection systems. As such, a service provider may deploy AI models across a wide variety of platforms including websites and applications accessible by customers and other end users.

When providing AI models and systems for automated and intelligent processes, such as when deploying LLMs, ML models, NNs, and other AI systems, extensive training and testing may be required so that model inferencing (e.g., the process of the AI model taking input data and generating an output prediction, decision, response, classification, or the like) is accurate, timely, and compliant with performance expectations. Generally, AI models may correspond to various types of artificial intelligences employed by computing systems, which may include ML models, such as LLMs and/or other generative AI models. AI models may be tested for latency and/or throughput during inferencing, such as the speed of generating an inference and/or amount or number of inferences or data that can be handled for inferencing. These metrics may indicate an overall performance of the AI model, such that the model may be deployed when meeting or exceeding certain benchmarks and/or thresholds. Other metrics may also be suitable for testing performance of different AI models, such as accuracy, time-to-first-token (TTFT), and the like.

However, conventional systems require live and real testing, which causes significant system resource usage and is time consuming for both manual efforts and system processing times for proper AI model execution and running during testing. Deploying certain types of LLMs and/or LLM components, such as long context transformers (e.g., those capable of handling 100K to 10M tokens), may be prohibitively expensive compared to other ML models, such as short context (e.g., 4K tokens) model variants. Transformers may generally correspond to a set of NNs for an LLM that may include an encoder, decoder, and/or self-attention capabilities including multi-head attention mechanisms. Transformers may be used by LLMs for transforming input sequences to output tokens. Token inputs and size limits of LLMs (and/or other Gen AI models, collectively referred to as LLMs for ease of may limit “tokens” or words, character sets, or combinations of words and punctuation that are used by LLMs when decomposing text for encoding and processing, and thus may limit LLM deployment and/or cause deployment to increase in cost and system resource usage. With LLMs that handle large token size limits, currently, it is both costly and time-consuming to benchmark the inference performance of LLMs on different GPUs and other hardware, software, and/or network configurations. This involves significant time and manual efforts, as well as GPU and other computing system resource costs, which increases operational expenses and delays in providing performance metrics to users. These existing solutions rely solely on empirical benchmarking, which is both resource-intensive and time-consuming.

As such, in various embodiments, a service provider may implement a quantitative analysis tool that utilizes a technique and algorithm for theoretical calculation of model performance metrics, which allows for analysis of model performance and determination of model optimizations. The tool may consider a model specification and build (e.g., an architecture of the model and/or model framework, as well as the specific build of the model, such as trained configurations, values, and functions), as well as model configurations for running the AI model on a processing unit. The tool may be implemented to run tests using the theoretical technique on different GPUs or other processing units and their corresponding specifications such that a model performance may be predicted. This allows for output of a throughput parameter, or other model performance metric, as well as any model optimizations to the model configuration. Further, once the model is deployed, the theoretical calculations may be compared to live and actual performance of the model in runtime and/or a production computing environment to assess the model performance and accuracy of the quantitative analysis tool.

Thus, a service provider may provide and utilize a programmatic and automated tool for theoretical analysis of AI models for model performance that may address the critical need to mitigate the resource usage and time costs associated with real model testing on actual processing units, cores, and/or systems. In this regard, a service provider may use such a framework and tool to more efficiently test AI models in a faster manner, where the AI models may be deployed for inferencing with different service provider computing systems and services. In this regard, a user may interact with a service provider through these computing systems and services, such as to process transactions electronically and/or engage in digital payments. Service providers may also or instead provide other computing services, including social networking, microblogging, media sharing, messaging, business and consumer platforms, etc. In order to utilize the computing services of a service provider, an account with the service provider may be established by providing account details, such as a login, password (or other authentication credential, such as a biometric fingerprint, retinal scan, etc.), identification information to establish the account (e.g., personal information for a user, business or merchant information for an entity, or other types of identification information including a name, address, and/or other information), and the like.

The user may also be required to provide financial information, including payment card (e.g., credit/debit card) information, bank account information, gift card information, benefits/incentives, and/or financial investments, which may be used to process transactions for items. The account creation may also be used to establish account funds and/or values, such as by transferring money into the account and/or establishing a credit limit and corresponding credit value that is available to the account and/or card. The online payment provider may provide digital wallet services, which may offer financial services to send, store, and receive money, process financial instruments, and/or provide transaction histories, including tokenization of digital wallet data for transaction processing. The application or website of the service provider, such as PAYPAL® or other online payment provider, may provide payments and the other transaction processing services.

Once the account of the user is established with the service provider, the user may utilize the account via one or more computing devices, such as a personal computer, tablet computer, mobile smart phone, or the like. The user may engage in one or more online or virtual interactions, such as browsing websites and data available with websites of merchants. In this regard, the transaction processor or other online service provider may provide computing services for electronic transaction processing, as well as other data processing services for other use of computing services on websites, applications, or other online portals of the merchant. These services may utilize different AI models requiring training, testing, and deployment for properly inferencing during runtime and in production computing environments. As such, the service provider may utilize an automated tool to compute theoretical model throughput parameters and other model performance metrics, which may be done without requiring real or live testing to minimize the impact on system resources and time.

In this regard, the quantitative analysis tool for AI model analysis may utilize one or more techniques and/or algorithms to compute model performance metrics. The performance metrics may be associated with an inference speed or latency, a TTFT, or other throughput parameter of AI model inferencing. The tool may utilize an algorithm to calculate a minimum theoretical latency, throughput, TTFT, or other value based on the model architecture, the specification of the GPU or other processing unit that the model is to be run on, and any other model configurations provided. This may allow for output of response time or latency time to an input text or an input set of tokens, an error rate, an inference speed, a data throughput amount or volume, or other throughput parameters. In this regard, the tool may analyze prefilling times and latencies for processing input sequences with decoding times and latencies for generating output tokens. As such, the tool may be deployed utilizing one or more formulas and algorithms for calculation of these latencies, which may allow for computation of AI model performance metrics.

Once deployed, the quantitative analysis tool may be utilized by users, such as data scientists and other users involved in AI model training, modeling, and testing, to analyze AI models computationally and without real deployment and execution on GPUs and other processing units. A user may access the tool and provide a model configuration for an AI model to be tested. The model configuration may include an AI model data package and/or model architecture, which may include an executable AI model file and/or location of the AI model on an AI model platform (e.g., online platform where AI models may be developed, tested, and executed). With the AI model, the model configurations may include hardware configurations for running the model, model versions, and/or model hyperparameters. The model configuration may further include parameters and/or a parameter size, an AI model size, GPU or other processing unit (including central processing units (CPUs), cloud machines or computes, etc.) architectures and/or specifications, computing power, a compute unified device architecture (CUDA) memory available to the GPU or other processing unit, and the like.

The quantitative analysis tool may then receive a request to generate a theoretical determination of a model throughput parameter associated with latency, TTFT, or the like. In this regard, the tool may calculate a first time associated with the prefill latency and a second time associated with the decoding latency of the AI model when run on the corresponding processing unit, which may be used in a final computation of the model's throughput parameter. The first time may be calculated using FLOPS (Floating Point Operations per Second) of prefilling and the GPU's capabilities or processing unit specification (e.g., hardware capabilities and/or hardware specifications of the GPU or other processing unit). This computation may further include additional information that may consider the required time to process the input sequence and calculate the initial hidden states before generating any tokens, which may include running the transformer model over the input sequence without producing any output tokens. The second time may be calculated using bytes of memory access by the model and the HBM (High Bandwidth Memory) of the GPU. As such, the second time may be calculated as the time required to generate each output token or the like.

For LLMs, the first and second times may be associated with an input sequence and/or input token(s), which may correspond to text having a length of characters, words, or the like. The first and second times may be computed based on the hidden states of the model, as well as the output of the model including any output tokens by the LLM (e.g., output text including conversational or natural language text). Once the first and second times, or other initial calculations, have been calculated, the model throughput parameter may be computed. For example, TTFT may be computed as a sum of the first and second times, whereas the theoretical peak latency may be determined based on the decoding time determined from the second time. Other model performance metrics for throughput parameters may be similarly computed. The quantitative analysis tool may then output the throughput parameter to the user via one or more user interfaces (UIs). With the throughput parameter, the tool may provide one or more model optimizations, such as different GPUs or other processing units to execute the AI model, optimizations to model configurations and/or architecture, and the like. The model optimizations may therefore indicate, from an analysis of the LLM or other AI model, a process or parameter of the model that may be changed, updated, or reconfigured for more efficient or accurate model inferencing.

As such, a service provider's system may implement a framework and analysis tool for analyzing and testing AI models in a more efficient, automated, and accurate manner, thereby reducing computing resources, manpower, and time for determining model throughput parameters and other model performance metrics. This allows for the service provider to determine model performance prior to deployment, as well as any model optimizations that may be performed so that deployment of the AI model may be improved, and the AI model may provide improved inferencing during production environment execution. The system may automate the process AI model testing without requiring active and real model execution on valuable system resources and processing units, ensuring and computing capabilities and resources are not wasted. As such, AI models may be trained and tested in a more efficient and faster manner, resulting in faster AI model optimization and deployment.

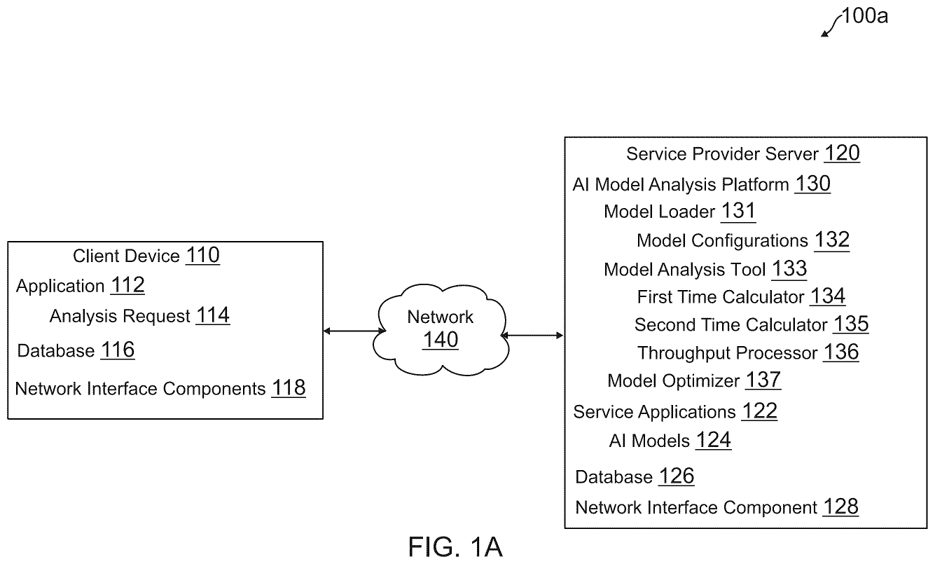

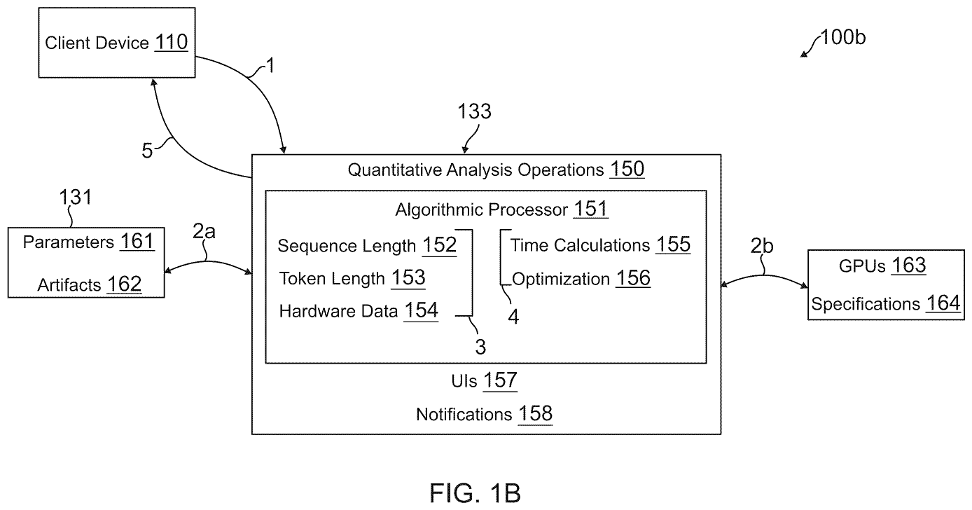

FIGS. 1A and 1B are block diagrams of networked systems 100a and 100b suitable for implementing the processes described herein, according to an embodiment. As shown, systems 100a and 100b may comprise or implement a plurality of devices, servers, and/or software components that operate to perform various methodologies in accordance with the described embodiments. Exemplary devices and servers may include device, stand-alone, and enterprise-class servers, operating an OS such as a MICROSOFT® OS, a UNIX® OS, a LINUX® OS, a mobile OS (e.g., iOS, Android, Google OS, etc.), a merchant and/or point-of-sale (POS) device OS, or another suitable device and/or server-based OS. It can be appreciated that the devices and/or servers illustrated in FIGS. 1A and 1B may be deployed in other ways and that the operations performed, and/or the services provided by such devices and/or servers may be combined or separated and may be performed by a greater number or fewer number of devices and/or servers. One or more devices and/or servers may be operated and/or maintained by the same or different entity.

System 100a includes a client device 110 and a service provider server 120 in communication over a network 140. Client device 110 may be utilized by an entity or a user (including end-users, merchants, businesses, etc.), such as an internal agent or employee or an external customer of service provider server 120, to communicate with service provider server 120 over network 140. Service provider server 120 may provide various data, operations, and other functions over network 140 to provide services to merchants, users, and computing devices. In this regard, client device 110 may be used to request an analysis of an AI model, such as an LLM, from service provider server 120, where the LLM may be used for inferencing in a computing environment and may be tested to determine inference speed or another throughput parameter. As such, service provider server 120 may perform AI model testing using a quantitative analysis tool, which may provide theoretical analysis of the AI model, as discussed herein.

Client device 110 and service provider server 120 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 100a, and/or accessible over network 140.

Client device 110 may be implemented as a communication device of a user, entity, or the like that may interact with service provider server 120. Client device 110 may utilize appropriate hardware and software configured for wired and/or wireless communication with service provider server 120. For example, in one embodiment, client device 110 may be implemented as a personal computer (PC), a smart phone, laptop/tablet computer, wristwatch with appropriate computer hardware resources, eyeglasses with appropriate computer hardware (e.g., GOOGLE GLASS ®), other type of wearable computing device, implantable communication devices, and/or other types of computing devices capable of transmitting and/or receiving data. Although only one device is shown, a plurality of devices may function similarly and/or be connected to provide the functionalities described herein.

Client device 110 of FIG. 1A includes and/or is associated with an application 112, a database 116, and a network interface component 118, implementations of which are discussed further below. The application 112 may correspond to executable processes, procedures, and/or applications with associated hardware. In other embodiments, client device 110 may include additional or different modules having specialized hardware and/or software as required.

Application 112 may correspond to one or more processes to execute software modules and associated components of client device 110 to provide features, services, and other operations for a user, such as a data scientist, user involved in AI modeling, a customer, or the like, to test AI models with service provider server 120. In this regard, application 112 may correspond to specialized software utilized by a user of client device 110 to generate and transmit an analysis request 114, which may correspond to a request or instruction to have a particular AI model tested for a throughput parameter, such as latency or speed for inferencing, token, data, or inferencing throughput (e.g., number of tokens or outputs), accuracy, or the like. In some embodiments, analysis request 114 may specify an AI model, such as an LLM, to be tested, which may identify the AI model in a testing environment and/or provide information from which the AI model can be loaded and/or tested. In other embodiments, analysis request 114 may include a data file or package of the AI model (e.g., a model executable package or code, model artifacts, etc.), or may provide AI model specifications and/or parameters including input sequences, output token size, number of active requests (e.g., concurrency number of requests that may be run and/or served concurrently by the LLM at a given time, which may be used to indicate how well the LLM performs at scale), GPU card or unit, or the like. Application 112 may also be utilized to review additional AI model configurations, which may be used to identify of how the AI model is to be run in a production computing environment. As such, responsive to analysis request 114, service provider server 120 may provide information regarding AI model performance and one or more throughput parameters requested by analysis request 114. Analysis request 114 may therefore be used to receive a response, report, and/or output of analytics in application 112, which may indicate a response time to an input text or an input set of tokens, an error rate, an inference speed, a concurrency metric for handling concurrent requests, and the like.

Application 112 may correspond to a general browser application configured to retrieve, present, and communicate information over the Internet (e.g., utilize resources on the World Wide Web) or a private network. For example, application 112 may provide a web browser, which may send and receive information over network 140, including retrieving website information, presenting the website information to the user, and/or communicating information to the website. However, in other examples, application 112 may include a dedicated application of service provider server 120 or other entity that may interact with service provider server 120 for AI model testing. Thus, application 112 may also correspond to different service applications and the like. When utilizing application 112 with service provider server 120, application 112 may transmit analysis request 114 to service provider server 120 and receive responses to executing AI testing operations with one or more AI models.

Client device 110 includes other applications as may be desired to provide features to client device 110. For example, these other applications may include security applications for implementing client-side security features, programmatic client applications for interfacing with appropriate application programming interfaces (APIs) over network 140, or other types of applications. Other applications on client device 110 may also include email, texting, voice and IM applications that allow a user to send and receive emails, calls, texts, and other notifications through network 140. In various embodiments, the other applications may include those that may be utilized in the course of model training, retraining, and/or content and other data unlearning. The other applications may include device interface applications and other display modules that may receive input from the user and/or output information to the user. For example, client device 110 may contain software programs, executable by a processor, including a graphical user interface (GUI) configured to provide an interface to the user. The other applications may use devices of client device 110, such as display devices capable of displaying information to users and other output devices, including speakers.

Client device 110 may further include or have access to database 116, which may correspond to different types of data storage and components including cloud computing storage nodes, remote data stores and database systems, distributed database systems over network 140, and the like used to store various applications and data. Database 116 may include, for example, identifiers such as operating system registry entries, cookies associated with application 112 and/or other applications, identifiers associated with hardware of client device 110, or other appropriate identifiers, such as identifiers used for payment/user/device authentication or identification, which may be communicated as identifying the user/client device 110 to service provider server 120.

Client device 110 includes at least one network interface component 118 adapted to communicate with service provider server 120 and/or other devices and servers. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency, infrared, Bluetooth, and near field communication devices.

Service provider server 120 may be maintained, for example, by an online service provider, which may provide computing services and operations via one or more digital platforms, applications, websites, and the like. Service provider server 120 may provide computing services to various entities, which may include intelligent automated processes, applications, and the like through ML models, NNs, LLMs, and other AI models and executable engines. As such, during the course of AI model training, service provider server 120 may provide processes for theoretical calculation and computation of a model throughput parameter or other model performance metric, which may be done without execute live tests on system processing units and using system resources. In one example, service provider server 120 may be provided by PAYPAL®, Inc. of San Jose, CA, USA. However, in other embodiments, service provider server 120 may be maintained by or include another type of service provider.

Service provider server 120 of FIG. 1A includes and/or is associated with an AI model analysis platform 130, service applications 122, a database 126, and a network interface component 128, implementations of which are discussed further below. AI model analysis platform 130 and service applications 122 may correspond to executable processes, procedures, and/or applications with associated hardware. In other embodiments, service provider server 120 may include additional or different modules having specialized hardware and/or software as required.

AI model analysis platform 130 may correspond to one or more processes to execute modules and associated specialized hardware of service provider server 120 to provide AI training, testing, and analyzing operations that may include one or more applications, operations, and/or components for a framework and processing pipeline to training and/or test AI models. In this regard, AI model analysis platform 130 may correspond to specialized hardware and/or software used by an internal agent, data scientist, administrator, or other user associated with client device 110 to perform model testing using a model loader 131 and a model analysis tool 133 for quantitative analysis of model performance metrics. For example, AI model analysis platform 130 may receive analysis request 114 from client device 110 for testing of a model and/or model configuration, which may indicate performance metrics, such as a model throughput parameter including latency, throughput, TTFT, accuracy, and the like. Analysis request 114 may be initiated via a manual request, a programmatic request, a part of regular maintenance, or based on a trigger or threshold to test an AI model. AI model analysis platform 130 may then determine an AI model for testing, which may be loaded by model loader 131. In this regard, model loader 131 may select, access, and/or load the AI model in question via an on-premises deployment (e.g., in a cloud storage/production environment or other storage directly accessibly by AI model analysis platform 130), via a third-party deployment and/or cloud environment, and/or elsewhere via API calls to corresponding systems. This AI model may correspond to one of AI models 124 and/or corresponding data files, model artifacts, and the like.

AI models 124 may correspond to an LLM or other generative AI, NN, ML decision trees or clustering algorithms, and the like, which were previously trained and/or configured or may be scheduled to be trained/retrained using training data, and which may be tested in response to analysis request 114. Initially, AI training operations may perform model training of AI models 124 using training data to train and configure AI models 124 for inferencing, such as predictive decisioning and outputs based on learning patterns and the like from training data. As such, data scientists and other model training teams may train AI models 124 for inferencing in production computing environments, including one or more LLMs, AI or ML models, NNs, conversational AIs, or the like. However, to assess the performance of AI models 124 prior to deployment and execution, model analysis tool 133 may be used.

AI models 124 may correspond to ML models, NNs, LLMs, or other AI models. With regard to LLMs and other generative AIs that may provide intelligent and predictive AI services through natural language, the LLMs may utilize one or more deep neural networks (DNNs), which may include trained layers having trained nodes connected between layers (e.g., where trained nodes may correspond to neurons connected by synapses between the layers). DNNs of LLMs, as well as other ML models, may be trained based on training data and selected features or variables configured to generate conversation or dialogue in natural language when responding to questions or queries, such as for inferencing when providing computing services via service applications 122. ML features may correspond to individual pieces, properties, characteristics, or other inputs for an ML model and may be used to cause an output by that ML model once the ML model has been trained using data for those features from training data. LLMs of AI models 124 may be used for intelligent and predictive outputs based on training on a set of documents, content, or other data, such as a corpus of documents that may serve as a knowledge base. The knowledge base may be general or generalized from a set of documents across multiple domains, subject areas, or the like, or the knowledge base, and subsequent LLM, may be domain specific. As such, LLMs may be trained on one or more corpora of general and/or domain documents, which may correspond to a general or domain-specific knowledge used during conversational responses and natural language communications. AI models 124 may include LLMs trained to provide predictive outputs, such as a response, score, likelihood, probability, or decision, associated with a particular prediction, classification, or categorization.

AI models 124 may further include trained nodes that have been configured and trained using training data. Training data may correspond to data records that have columns or other data representations and stored data values (e.g., in rows for the data tables having feature columns) for the features. When building AI models 124, training data may be used to generate one or more classifiers and provide recommendations, predictions, or other outputs based on those classifications and an ML or NN model algorithm and architecture. For example, with LLMs, training data may correspond to different corpora of documents and information, which may then allow the models to respond intelligently based on learning for such corpora. The architecture for the AI models 124 may correspond to different types of AI models, such as DNNs, ML decision trees and/or ML clustering models, LLMs and other generative AI, and other types of AI architectures, which may be trained using corresponding AI algorithms. The training data may be used to determine features, such as through feature extraction and feature selection using the input training data.

For example, DNN models and the like that may be implemented with LLMs may include one or more trained layers each include one or more of nodes, including an input layer, a hidden layer, and an output layer; however, different layers may also be utilized. As many hidden layers as necessary or appropriate may be utilized, and the hidden layers may include one or more layers used to generate vectors or embeddings used as inputs to other layers and/or models. In some embodiments, each node within a layer may be connected to a node within an adjacent layer, where a set of input values may be used to generate one or more output values or classifications. Within the input layer, each node may correspond to a distinct attribute or input data type for features or variables that may be used for training and intelligent outputs, for example, using feature or attribute extraction with the training data.

Thereafter, the hidden layer(s) may be trained to have corresponding weights, activation functions, and the like using a DNN algorithm, computation, and/or technique. For example, each node in the hidden layer generates a representation, which may include a mathematical computation (or algorithm) that produces a value based on the input values of the input nodes. For LLMs, representations of the hidden layer (e.g., computations, which represent algorithmic predictions based on the training algorithm(s), which may correspond to mathematical representations of data processing from the node and/or previous nodes) may be decoded to output tokens, where each “token” output by an LLM may correspond to words, character sets, or combinations of words and punctuation, such as a basic unit of data that may be input/output by an LLM. Consequently, LLMs may take input tokens (e.g., natural language questions, prompts, and the like) of a certain sequence length and/or size and output tokens of a corresponding token size. A transformer model, such as a NN that may be trained to learn and identify context or other linguistic task in input sequences, may also be used to represent one or more LLMs for computation of certain times to process input sequences. Thus, the transformer model may correspond to a NN or DNN that learns context and meaning through relationships in sequential data, and may correspond to the LLM being tested. However, the transformer model may not be required to perform actual inferencing that is utilized for a specific purpose and may instead be relied upon to determine a time to process the input sequence (e.g., by taking input tokens having characters and words in natural language), encoding the input sequence to embeddings or other vectors, and calculating initial hidden states. A time to perform this process may be monitored, determined, and/or predicted.

The DNN, ML, or other AI architecture and/or algorithm may assign different weights to each of the data values for the hidden states that may be encoded and calculated. The hidden layer nodes may include and/or utilize different algorithms and/or different weights assigned to the input data and may therefore produce a different value based on the input values. The values generated by the hidden layer nodes may be used by the output layer node(s) to produce one or more output values (e.g., by decoding the vectors, values, etc., from the hidden states of the hidden layers) for ML models that attempt to classify and/or categorize the input feature data and/or data records. Thus, when the AI models 124 are used to perform a predictive analysis and output, the input data may provide a corresponding output based on the trained classifications.

Layers, branches, clusters, or the like of the AI models 124 may be trained by using training data associated with data records of interest. By providing training data, the nodes in the hidden layer may be trained (adjusted) such that an optimal output (e.g., a classification) is produced in the output layer based on the training data. By continuously providing different sets of training data and/or penalizing the AI models 124 when the outputs are incorrect, the AI models 124 (and specifically, the representations of the nodes in the hidden layer) may be trained (adjusted) to improve its performance in data classifications and predictions. Adjusting of the AI models 124 may include adjusting the weights associated with trained nodes in the hidden layer. However, to provide evaluation of AI models 124 prior to deployment (e.g., based on the model configurations and/or model artifacts prior to final model training and release) and/or during deployment, model analysis tool 133 may be utilized. Model analysis tool 133 may enable performance testing without requiring specific use of processing units and components of service provider server 120 for model execution and real or live model performance testing, and as such, may provide a more efficient model training platform and tool.

In this regard, a model loader 131 may initially be used by client device 110, such as when a user utilizes application 112 to access AI model analysis platform 130. Model loader 131 may allow the user to specify model configurations 132 for an AI model to be tested and/or analyzed, which may correspond to the model architecture, parameters and/or parameter size of model parameters, a model size, features, input/output size, concurrency (number of concurrent requests to be handled and/or concurrently allowed), model artifacts, and the like. Model configurations 132 may also correspond to the processing unit designated to execute the AI model to be tested, such as a GPU and/or set of GPUs that may be assigned to and/or utilized as a compute or pool of machines for executing the designated AI model. In this regard, model configurations 132 for the processing unit may identify the GPU, CPU, or other processing unit, and/or may correspond to processing unit specifications, such as GPU architecture of a GPU, a computing power of a GPU or other processing unit, memory and/or memory speed of the processing unit, a CUDA memory available to the GPU, and the like. Model configurations 132 may be received from input to one or more UIs.

Model configurations 132 may be provided to model analysis tool 133 based on and/or in response to analysis request 114, which may be used to determine a throughput parameter or other model performance metric of the AI model selected. In this regard, model analysis tool 133 may process analysis request 114 to determine the specified model performance metrics requested for analysis and output. The metrics may include model latency or inference speed, throughput, TTFT, accuracy, or other metrics associated with model inferencing. For different model metrics, one or more of a first time calculator 134, a second time calculator 135, a throughput processor 136, and/or a model optimizer 137 may be used for model performance metric and/or throughput parameter analysis. In this regard, first time calculator 134 may compute and calculate a first time that it is predicted for the AI model process input data, such as a specified LLM to process an input sequence of text or token having a sequence length. First time calculator 134 may receive an input sequence length and may determine the first time based on how long it is predicted for the LLM to take to process the input sequence length prior to or without producing any output tokens. This determination may be done by processing the input sequence using a transformer model and calculating initial hidden states without output token generation. This may correspond to a prefill latency of the LLM or another AI model.

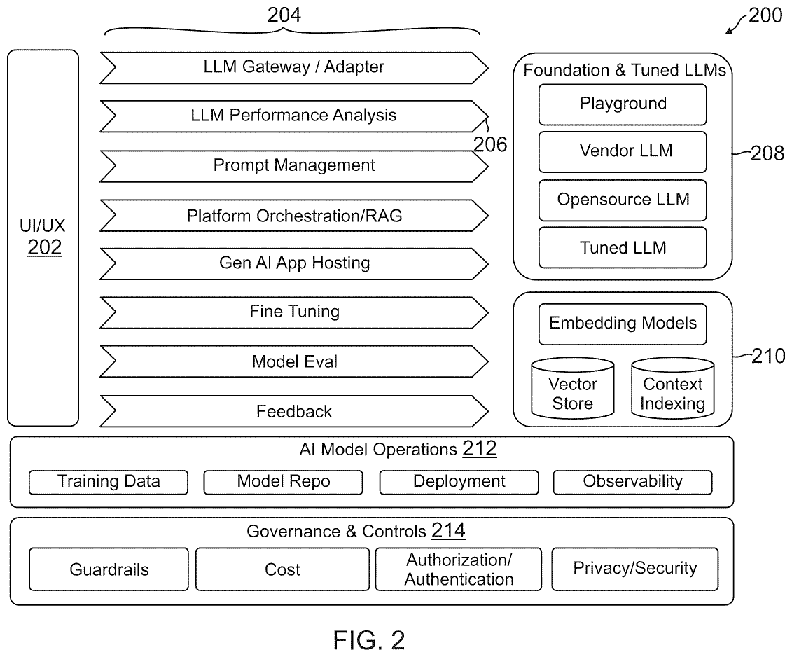

Second time calculator 135 may be used to determine a second time that it is predicted for the AI model to produce an output, such as how long the LLM is predicted to take when producing output tokens from the initial hidden state and/or encodings from the hidden states. Second time calculator 135 may determine the second time based on the bytes of memory access and the number and/or size of the output tokens. This second time may correspond to a decoding latency of the AI model. Throughput processor 136 may then calculate the model performance metric, such as a TTFT or other throughput parameter, based on the first time and the second time, such as a sum of those times. Throughput processor 136 may also calculate other metrics including accuracy, any latencies, throughputs, and the like, and may also use a number of concurrent requests or other concurrency of the AI model to weight and/or calculate the performance metric. Model optimizer 137 may then be used to determine any model optimizations that may be available, such as changes to the processing unit (e.g., GPU and/or GPU architecture or specification), which may better optimize performance of the AI model. In this regard, model optimizer 137 may compare the model performance metrics for different GPU configurations, as well as model architectures and/or parameters (e.g., input/output token size, concurrency, etc.), to determine model optimizations. The operations of AI model analysis platform 130 for model testing are discussed in further detail below with regard to FIGS. 2-4.

Service applications 122 may correspond to one or more processes to execute modules and associated specialized hardware of service provider server 120 to process a transaction and/or provide other computing services to users. For example, service applications 122 may be used to process payments and other services to one or more users, merchants, and/or other entities for transactions, where AI model analysis platform 130 may be used for testing of AI models 124 utilized by service applications 122 for inferencing and other outputs. In this regard, accounts of users and entities may be used to send and receive payments, including those payments that may be enabled through a website and/or application of users, merchants, and other transaction participants. A payment account may be accessed and/or used through a browser application and/or dedicated payment application executed by a device, such a payment and/or digital wallet application. Service applications 122 may process payments and may provide transaction histories to client device 110 and/or another user's device or account for transaction authorization, approval, or denial of the transaction for placement and/or release of the funds, including transfer of the funds between accounts based on compliance investigations.

Further, service applications 122 may provide different computing services, including social networking, microblogging, media sharing, messaging, business and consumer platforms, etc. These computing services may be used by customers and users, and therefore AI models 124 may be used to provide intelligent outputs through inferencing, decision-making, predicting, and the like that may be utilized during the provision of computing services to users and devices. In this regard, AI models 124 may assist with intelligent and automated computing services provided to users through predictive decisioning and/or outputs when performing AI inferencing. As such, ML AI model analysis platform 130 may be used for testing of AI models 124 to provide models that perform well or within desired performance metrics in production.

Service applications 122 as may provide additional features to service provider server 120. For example, service applications 122 may include security applications for implementing server-side security features, programmatic client applications for interfacing with appropriate APIs over network 140, or other types of applications. Service applications 122 may contain software programs, executable by a processor, including one or more GUIs and the like, configured to provide an interface to the user when accessing service provider server 120, where the user or other users may interact with the GUI to view and communicate information more easily. Service applications 122 may include additional connection and/or communication applications, which may be utilized to communicate information to over network 140.

Additionally, service provider server 120 includes or may access database 126. Database 126 may store various identifiers associated with client device 110. Database 126 may also store account data, including payment instruments, financial information, account balances, and authentication credentials, as well as transaction processing histories and data for processed transactions. Database 126 may include information used during AI service provision by AI models 124 and the like, such as trained models, packages, and/or model artifacts, knowledge base documents and data, and the like. Although database 126 is shown as residing on service provider server 120 as a database, in other embodiments, other types of data storage and components may be used including cloud computing storage nodes, remote data stores and database systems, distributed database systems over network 140 and/or of a computing system associated with service provider server 120, and the like.

Service provider server 120 may include at least one network interface component 128 adapted to communicate client device 110 and/or other devices and servers over network 140. In various embodiments, network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including WiFi, microwave, radio frequency (RF), and infrared (IR) communication devices.

Network 140 may be implemented as a single network or a combination of multiple networks. For example, in various embodiments, network 140 may include the Internet or one or more intranets, landline networks, wireless networks, and/or other appropriate types of networks. Thus, network 140 may correspond to small scale communication networks, such as a private or local area network, or a larger scale network, such as a wide area network or the Internet, accessible by the various components of system 100a.

Referring now to FIG. 1B, in system 100b, a more detailed view of model analysis tool 133 is shown for quantitative analysis operations 150 that may be performed using an algorithmic processor 151 that includes and executes the first time calculator 134, second time calculator 135, and throughput processor 136 of model analysis tool 133. System 100b shows a more detailed implementation of some of the components in system 100a, which may interact when performing AI model testing (e.g., through API calls, messages, memory accesses, etc.). In this regard, initially, client device 110 may execute an API call for an event 1, where event 1 may correspond to a call to, and interaction with, model analysis tool 133 for service provider server 120. The API call at event 1 may correspond to analysis request 114 to test an AI model and/or model configurations 132 that may be selected with and/or uploaded to model loader 131. The API call may also designate processing unit specifications, model performance metrics, and the like for testing.

As such, the API call may designate a data load for processing by quantitative analysis operations 150. To perform model testing based on the specified data load, quantitative analysis operations 150 performs API calls to separate processors and/or resources. At an event 2a for these API calls, quantitative analysis operations 150 may call model loader 131 for model configurations 132 that may include parameters 161 and/or artifacts 162 for the AI model. These may be used to determine different model information, such as an input/output sequence or token length, request concurrency, model and/or model parameter size, and the like. At an event 2b, quantitative analysis operations 150 further calls GPUs 163 to determine specifications 164. Specifications 164 may include GPU or other processing unit specifications, such as speed, processing power, bytes of memory access, CUDA memory available, etc. Events 2a and 2b may occur substantially simultaneously and/or in coordination for model testing.

Quantitative analysis operations 150 may then utilize algorithmic processor 151 to calculate, using one or more algorithms, different times and/or other variables usable to compute model performance metrics. In this regard, as input, algorithmic processor 151, at an event 3, takes a sequence length 152, a token length 153, and hardware data 154 as input to produce outputs for model performance metric determination. Sequence length 152, token length 153, and hardware data 154 may be determined from the API calls at events 2a and 2b to model loader 131 and GPUs 163, respectively. Algorithmic processor 151 implements one or more algorithms for processing sequence length 152, token length 153, and hardware data 154 at event 3, and, at an event 4, outputs time calculations 155 and optimizations 156.

Time calculations 155 may correspond to theoretical or predicted times to perform certain operations by the AI model based on the received model configurations, and optimizations 156 may provide any changes to the model configurations that may result in better model, or corresponding system, performance. To output time calculations 155 and optimizations 156, UIs 157 and notifications 158 may be provided to client device 110. As such, at an event 5, model analysis tool 133 responds to client device 110 through one or more API calls that may present and/or provide data in UIs 157 for time calculations 155 and optimizations 156. Notifications 158 may provide additional information regarding time calculations 155 and optimizations 156, as well as the request, for viewing through UIs 157.

FIG. 2 is an exemplary computing architecture 200 of a service provider that provides a quantitative analysis tool of AI models for inferencing speed and performance, according to an embodiment. Computing architecture 200 may include components of service provider server 120 that may be utilized for AI model evaluation and testing through quantitative analysis using theoretical computations, as discussed in reference to systems 100a and 100b of FIGS. 1A and 1B. In this regard, computing architecture 200 includes an AI modeling and deployment platform where a UI/user experience (UX) 202 provides an interface to and use of a modeling platform for ML modeling, such as LLM training and testing.

In computing architecture 200 of FIG. 2, UI/UX 202 provides an entry point and portal for use of the AI modeling and deployment platform. UI/UX 202 provides UIs and processing flows that may be utilized by a user to connect, load, train, and/or tune AI models, such as LLMs and other generative AIs. In this regard, processing flows 204 provide different operations and tools for AI modeling, which may include an LLM performance analysis 206 that is associated with AI model testing and evaluation for performance metrics, such as throughput parameters of LLMs, and other similar analyses. LLM performance analysis 206 may include one or more operations for theoretical computation of model throughput parameters, such as inference speed, latency while inferencing, data throughput, and/or TTFT, although other model performance metrics may also be tested including failure rate, accuracy, etc.

Processing flows 204 may further include operations and tools for an LLM gateway/adapter to adapt and utilize foundation and tuned LLMs (e.g., very large deep learning models that may be pretrained and tuned for immediate deployment) and/or embedding models 210 (e.g., models used to convert words, phrases, sentences, etc., to embeddings or other vectors for analysis and ML processing, such as through representations in vector spaces). Embedding models 210 may include a vector store of generated embeddings, or vector representations of words, phrases, and the like, as well as a context indexing for context of texts and other language. Processing flows 204 may further include prompt management for LLM prompts, platform orchestration/retrieval augmented generation (RAG) for LLM resources and knowledge bases, generative AI application hosting for applications hosted by service provider server 120, fine tuning for AI model fine tuning after training on feedback and the like, model evaluation for model monitoring and performance analysis during runtime, and/or feedback for handling user feedback to LLM outputs. Processing flows 204 may be used to interact with AI model operations 212 to perform model training, testing, and deployment, as well as model observation during runtime and inferencing for further model optimization or fine tuning. A governance and controls system 214 may further implement model safeguards and/or enforce risk and compliance requirements on model performance and inferencing, such as model guardrails to prevent certain model behaviors that may adversely affect systems or UXs, model costs restrictions or requirements on model resource usage, authentication and/or authorization for model training and deployment, and/or privacy/security for model training data and/or model inferencing based on privacy protected data.

With regard to LLM performance analysis 206, one or more operations of the processing flow may implement one or more algorithmic processes or techniques for calculation of a model throughput parameter or other model performance metric. For inference speeds of LLMs, different latencies may be calculated including a prefilling latency and/or a decoding latency. With regard to a prefilling latency, a theoretical time to prefill a memory of a GPU may be calculated. Prefilling latency may correspond to a time required to process the input sequence and calculate the initial hidden states before generating any tokens. This may be determined using a transformer model of the AI model and/or used to test the AI model, where the transformer model may correspond to a model trained for transforming input sequences to output tokens. The prefilling latency may be determined based on an amount of time for the transformer model to process the input sequence, but without producing any output tokens. With regard to prefilling latency, this may be theoretically calculated or predicted as the FLOP of prefilling divided by the GPU's FLOP per second.

With regard to decoding latency, a theoretical time to decode the hidden state information, encodings, embeddings, or other vector or value representations from the hidden states may be determined. Decoding latency may correspond to a time required to generate each output token. For a TTFT, this may correspond to the decoding latency for generating the first token. A theoretical decoding latency may be calculated as the bytes of memory access divided by the GPU's HBM bandwidth. The bytes of memory access name be calculated as the number of output tokens multiplied by the sum of the model weights and a key-value (KV) cache size. With regard to a TTFT for the throughput parameter calculation, LLM performance analysis 206 may calculate the TTFT as the sum of these two times, the prefilling latency and the decoding latency for the first token output. As such, the formula for calculating TTFT that may be utilized by LLM performance analysis 206 may correspond to the following Equation 1:

### Equation 1

### TTFT

=prefill latency+decoding latency for the first output token=(FLOP of prefilling/FLOP per second of GPU)+(1*(model weights+KV Cache)/HBM bandwidth of GPU)

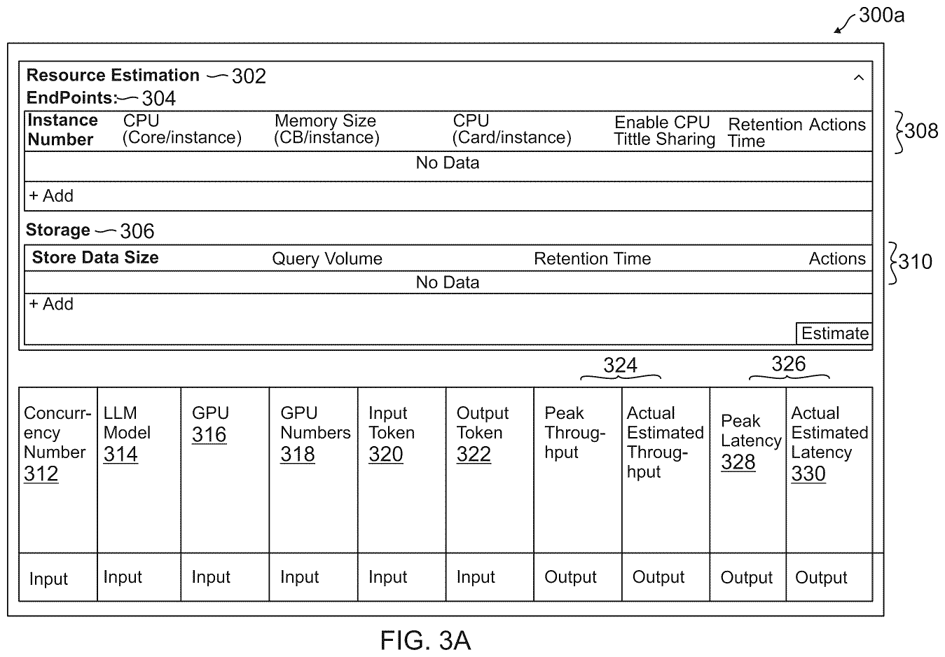

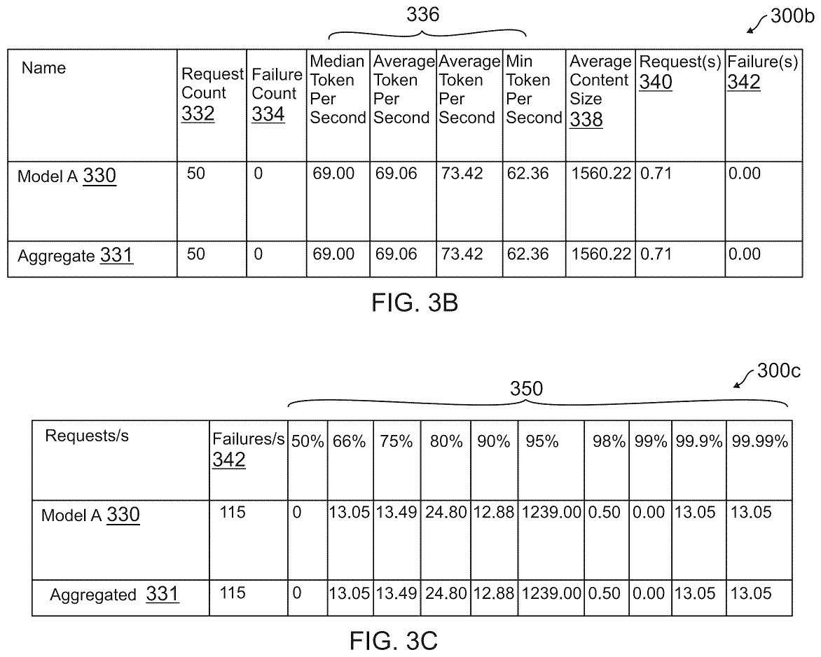

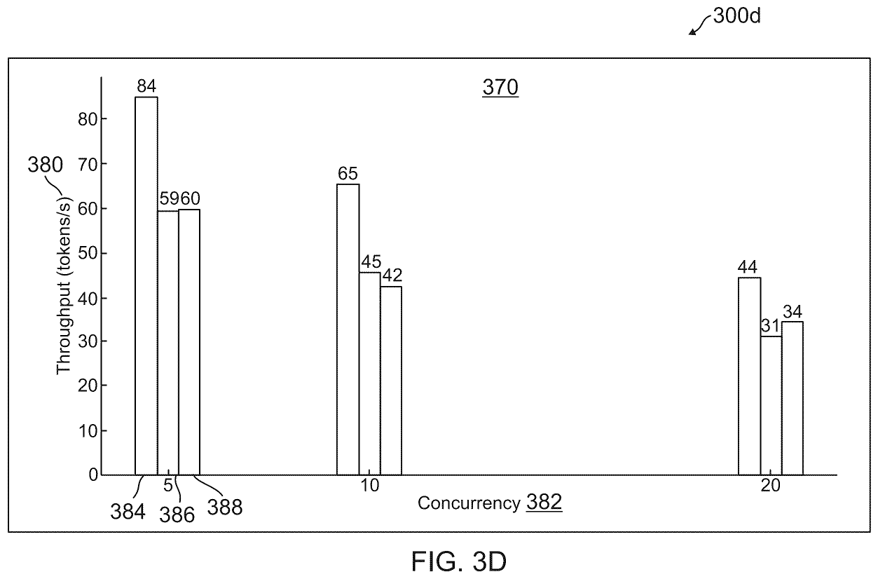

FIGS. 3A-3D are exemplary diagrams 300a-300d of AI model throughputs as tested by a quantitative analysis tool, according to various embodiments. Diagrams 300a-300d include selected model configurations for AI model testing and corresponding throughput parameters calculated for that AI model, which may correspond to inputs and outputs, respectively of model analysis tool 133 of service provider server 120 in systems 100a and 100b of FIGS. 1A and 1B. As such, diagrams 300a-300d show the model configurations that may be required to be specified to enable algorithmic processor 151 to calculate model performance metrics theoretically to reduce model testing resource usage, cost, and time, thereby provide a more efficient model testing tool.

In diagram 300a of FIG. 3A, a resource estimation 302 may be utilized to specify the resources that may be allocated to an AI model, such as an LLM, for execution and usage in a production computing system where the AI model is to be run. For example, resource estimation 302 may specify endpoints 304 that may run the LLM model and a storage 306 from which the model, model artifacts, knowledge base or searchable data repository for a RAG process, and the like may load data and to which data may be stored including LLM outputs. For endpoints 304, endpoint configurations 308 may include information including a number of instances of the endpoints, a CPU, a memory size, a GPU, whether GPU time sharing is enabled, a retention time (e.g., how long an endpoint may be made available and/or data stored or retained for processing at the endpoint), and/or actions that the endpoint may perform for LLM execution (e.g., prompting and/or inferencing allowed). For storage 306, the information for storage configurations 310 may include data size of the data store or other storage component, a query volume for incoming query handling, a retention time, and/or actions. As such, endpoint configurations 308 and storage configurations 310 may identify the resources that may be allocated to the LLM and how the LLM may use the resources during execution. However, resource estimation 302 may not actually allocate such resources for testing of the LLM or other AI model, and instead the parameters and specifications may be entered to imitate or mimic a test and/or production run of the AI model, while computing test and/or live execution results in a theoretical manner.

In diagram 300a, the user is further able to specify how the LLM may run in different instances for inferencing on the resources allocated. In this regard, the LLM may have specifications and configurations for each LLM instance execution when responding to a prompt. Other AI models may have similar configurations for executing and running in a production environment. For the LLM being testing using the specifications provide in diagram 300a, a user may specify a concurrency number 312 for a maximum number of concurrent requests that may be handled by the LLM. LLM model 314 may specify the particular LLM model, which may allow for retrieval of model artifacts, a data file, or the like, as well as test result correlation to a model name or identifier. GPU 316 and GPU numbers 318 may allow the user to specify certain GPU specifications for LLM execution by the GPUs available to endpoints 304, including a GPU name, model, or specifications and/or a number of those GPUs to execute the different instances of the LLM based on concurrency number 312.

Additional input for LLM testing may include an input token 320, such as an input token size or sequence length of an input prompt, question, or other natural language to the LLM, and an output token 322, such as a corresponding token size or sequence length of tokens that may be output by the LLM. Thereafter, a theoretical test may be run using algorithmic processor 151, such as using the processes described in FIG. 2. As such, outputs may be provided by the quantitative analysis tool as shown in diagram 300a, which may include throughputs 324 including a peak and actual estimated throughput and/or latencies 326 including a peak latency 328 and an actual estimated latency 330. Throughputs 324 may indicate and/or measure, theoretically, a number of successful operations per second or other unit of time, which may indicate how well the LLM may handle requests simultaneously (e.g., based on concurrency number 312). Throughput parameters may therefore be associated with those successful operations, which may include inference speed or latency, as well as other metrics for LLM data processing. Latencies 326 may indicate and/or measure, theoretically, the time between when a request is received and when a response is provided to the request.

In diagram 300b, a table is shown for a model A 330 that may be tested for different throughput parameters based on model configurations specified and tests to be performed using theoretical analyses and computations. In this regard, model A 330 is designated in a column having the computations for model throughput in a first row for model 300 and aggregated computations 331 in a second row. With regard to requests to model A 330, such as prompts or the like that may query an LLM with a set of data and/or examples with instructions for a response, a request count 332 and a failure count 334 may display computations for a concurrent number of requests that were used when computing the throughput parameters for model A 330. In this regard, it is determined that for a request count 332 of 50, 0 failures are predicted for failure count 334. Thus, model A 330 is expected to have a 100% success rate for concurrent requests up to 50. Aggregated computations 331 further show an aggregate or average value for each column depending on the previous tests run, which may vary based on different model specifications provided. In some embodiments, aggregated computations 331 may also show aggregations of computations for different tests that may be run for different models, hardware specifications, and the like.

Further in the table shown in diagram 300b, token throughput parameters for token outputs may be calculated using the processes described herein. In this regard, token latencies 336 are shown in diagram 300b, which may include times (e.g., an amount or length of time taken to process tokens) for a median token per second, an average token per second, a maximum token per second, and/or a minimum token per second. This allows for evaluation of the model's different inference speeds under different situations or circumstances, which allows for understanding of how well the model may behave in production computing environments. An average content size 338 may indicate an average token size, length, or the like of output tokens, such as an average word or character count or other data size for output text or other output inferences by model A 330. Requests 340 may show a percentage value of request count 332 for a maximum number of concurrent requests. Similarly, failures 342 may show a failure percentage for the failures per the maximum number of concurrent requests and/or the number of tested concurrent requests. Since a failure count 334 of 0 was used, failures 342 may show 0%.

In diagram 300c, an extension of the table for model A 330 is shown with further information. In this regard, the computations shown in the rows for model A 330 and aggregated computations 331 may include a breakdown of calculated token throughput per second for theoretical peak performance percentages 350. For example, with theoretical peak performance percentages 350 (second column of 350) of 66%, the calculated token throughput per second may be 13.05 tokens per second. Calculation of theoretical peak performance percentages 350 allows a user to view theoretical performances of model A 330 under different circumstances and scenarios.

In diagram 300d, a throughput performance comparison 370 is shown, for example, in a user interface and/or window in a user interface of model analysis tool 133, where a user may view the theoretical calculations of model throughput or other performance metric with an actual throughput and benchmark throughput. Throughput performance comparison 370 may show an output of model analysis tool 133 from execution of algorithmic processor 151 by quantitative analysis operations 150. Throughput performance comparison 370 compares throughput tokens per second 380 for the three calculated and measured throughputs against concurrency 382 for different concurrent requests that may be processed by the LLM for user requests on the specified hardware, such as the selected GPU(s) for the model platform executing the LLM.

In throughput performance comparison 370, throughput tokens per second 380 is calculated for a theoretical throughput 384, an estimated actual throughput 386, and a benchmark throughput 388 for three values for concurrency 382. By measuring theoretical throughput 384 for different concurrencies of user requests and model executions or inferences, model behavior and performance may be theoretically calculated before (or during) deployment, and then measured against estimated actual throughput 386 and benchmark throughput 388 determined during model deployment and execution, which allows for a determination of theoretical accuracy of throughput tokens per second 380. Thus, model analysis tool 133 may provide information for pre-deployment of AI models, including throughput performance of LLMs, as well as live or real model performance monitoring.

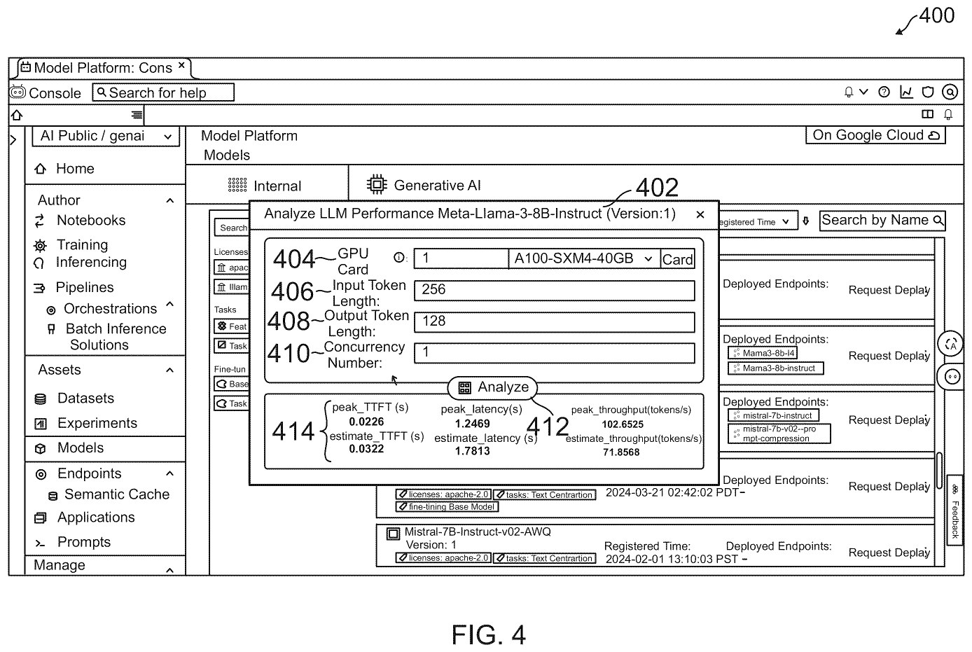

FIG. 4 is an exemplary user interface (UI) 400 provided by a quantitative analysis tool for testing AI model inference speed and performance, according to various embodiments. UI 400 may be output on and/or by client device 110 in application 112 based on a use of model analysis tool 133 for model analytics including model throughput parameter determination. In this regard, UI 400 may correspond to a website or software application UI where a user may utilize quantitative analysis operations 150 for theoretical computation and analysis of model configurations for the throughput parameters or other model performance metrics.

In UI 400, displayable UI components for model analysis tool 133 are shown with a popup or window for an LLM performance analysis 402 where a user may specify and/or input the model configuration to be tested using the algorithmic model testing processes described herein for determination of a theoretical throughput parameter or another model performance metric. In this regard, LLM performance analysis 402 includes data fields for a GPU card 404, an input token length 406, an output token length 408, and/or a concurrency number 410. GPU card 404 may specify one or more GPUs or other processing units that may execute the model in production. GPU card 404 may be selected based on identification of a GPU model or the like, as well as by input of individual performance and/or capabilities of the GPU (e.g., processing power/speed, memory size and/or access speed, etc.).

Input token length 406 and output token length 408 may be associated with allowable input data size and average or maximum output data size. In this regard, input token length 406 may specify a maximum, or average, number of characters, words, or the like, or other data measurement, that may be accepted as input in a single prompt, request, and/or call to an LLM. Input token length 406 may be limit the size of input data to the LLM, such as to prevent excess hallucinations, incorrect or nonsensical responses from too large of a prompt scope, or the like. With output token length 408, the LLM may be limited to or may provide output tokens of a maximum or average size. Concurrency number 410 may identify the number of allowable concurrent requests to the LLM and/or number of requests that the LLM may handle concurrently, which may affect LLM performance.

Although in UI 400 the user is specifying the model configurations, additional model configurations may also be provided to model analysis tool 133 via an upload of data, online repository or database of the data, and/or other system component or storage of service provider server 120. Thereafter, the user may select an analyze button 412 to execute the theoretical tests through algorithmic computations of the throughput parameters requested by the user. LLM performance analysis 402 may then provide throughput parameter values 414, which may be used to analyze and evaluate the LLMs performance under the conditions and model configurations specified in the fields of LLM performance analysis 402. For example, throughput parameter values 414 may include values for a peak and estimated TTFT, a peak and estimated latency, and a peak and estimated throughput. As such, LLM performance analysis 402 may provide a fast and efficient analysis of LLM performance at scale and without utilizing excessive system resources for real testing on GPUs or other processing units. These tests may also provide reliable and accurate results, which may be compared to performance of the LLM in production for accuracy evaluation.

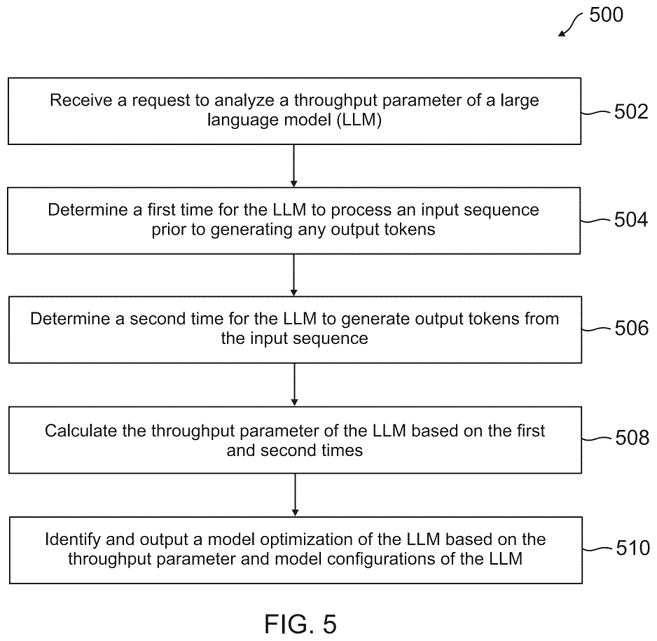

FIG. 5 is a flowchart 500 of operations performed by a quantitative analysis tool or system for inference speed and performance of AI models, according to an embodiment. For example, flowchart 500 may be performed by AI model analysis platform 130 using model loader 131 with model analysis tool 133. In this regard, AI model analysis platform 130 may receive a request from application 112 on client device 110 to analyze an AI model using AI model analysis platform 130. In other embodiments, the request need not be received by client device 110, but instead be received by another device or entity, including the service provider, such as when models are uploaded and/or periodically to test model performance, updates, and the like over time. Note that one or more steps, processes, and methods described herein of flowchart 500 may be omitted, performed in a different sequence, or combined as desired or appropriate.

At step 502 of flowchart 500, a request to analyze a throughput parameter of an LLM is received. In system 100a of FIG. 1A, client device 110 may transmit analysis request 114 to service provider server 120 so that one of AI models 124 may be tested for model performance, such as through analysis of a throughput parameter of the model. Analysis request 114 may specify the particular one of AI models 124 or may provide model configurations 132 that may be tested through a theoretical analysis of quantitative model performance. Model loader 131 may be used to load, deploy, and/or access an AI model, which may include one or more files for the model, model artifacts, or the like. Additionally, model configurations 132 may be designated by analysis request 114 for testing. Additionally, model configurations 132 may include the processing unit and/or specifications of the processing units to run the AI model, as well as request concurrency for handling by the model and/or model performance metrics, such as a throughput parameter of model throughput (e.g., processing by the model from input to output).

At step 504, a first time for the LLM to process an input sequence prior to generating any output tokens is determined. From model configurations 132, model analysis tool 133 may identify, extract, and/or determine model and processing unit configurations and parameters for model input processing. In this regard, first time calculator 134 may determine a prefilling latency for an amount of time required to process an input sequence and calculate the initial hidden states before generating any tokens. To do this for an LLM, first time calculator 134 may utilize a transformer model and run the model over the input sequence of text or an LLM token without producing any output tokens. The first time may be calculated using FLOPS (Floating Point Operations per Second) of prefilling for the AI model compared to the FLOPS of the GPU's capabilities or specifications. As such, a theoretical prefill latency may correspond to a number or amount of FLOPS for prefilling (e.g., processing an input sequence) processing that may be performed per second of the GPU or another processing unit, where the processing unit may correspond to a standard or benchmark, or the unit selected by the user. First time calculator 134 may further consider the request or model execution instance concurrency on the processing unit, such as a number of concurrently handled requests for different model instances.

At step 506, a second time for the LLM to generate output tokens from the input sequence is determined. Model analysis tool 133 may further calculate, from the model and processing unit configurations and parameters for model input processing, a decoding latency that represents the time require to generate each output token using second time calculator 135. For a TTFT or the like, the decoding latency may be associated with the time to generate the first token, but the decoding latency may also be associated with the time to decode all tokens, a majority of tokens so that a response may begin to be formulated or provided, an average token decoding time, or the like. To calculate the decoding latency, second time calculator 135 may utilize a number of bytes of memory access provided by the GPU or other processing units (e.g., the memory access capability of the GPU) per the processing unit's HBM bandwidth. The bytes of memory access may be determined based on a number of outputs tokens multiplied by a sum of the model weights and the size of the Key Value (KV) cache. As such, second time calculator 135 may calculate a time it takes to decode vectors, embeddings, values, or the like from the encoded hidden states of the LLM after processing one or more input sequences or tokens. In some embodiments, this time may be calculated based on decoding the hidden states of the transformer model once encoded by first time calculator 134.

At step 508, the throughput parameter of the LLM is calculated based on the first and second times. Throughput parameters may correspond to those parameters that indicate how the LLM behaves from input to output, or throughput, of a request to a response, such as by processing input sequences or tokens and outputting tokens for an answer in natural language. Throughput parameters of the LLM may be calculated for different performance metrics of the LLM, such as a latency, data or token throughput, inference speed, TTFT, or the like. In other embodiments, other performance metrics may be calculated, such as model accuracy, hallucinations, and the like. In this regard, for a TTFT or other inference speed of the LLM, throughput processor 136 may utilize the first time and second time, as calculated and determined by first time calculator 134 and second time calculator 135, to calculate a total inference time that it takes from an input sequence to a first output token, or a TTFT. As such, for TTFT, the sum of the prefill latency and the decoding latency may be used as the throughput parameter.

At step 510, a model optimization of the LLM is identified and output based on the throughput parameter and model configurations of the LLM. Once the TTFT or other throughput parameter is calculated, model optimizer 137 may compare and/or utilize that value to determine if any changes to model configurations, such as model parameters, input/output sequence or token size, GPU or other processing unit specification, or the like may be changed or reconfigured for more efficient, more accurate, or faster inferencing, such as improved inferencing time and/or reduce resource usage when inferencing, as well as request concurrency for better performance or increased handling capabilities when handling concurrent requests. Model optimizer 137 may provide the model optimization for output with the throughput parameter from throughput processor 136. As such, client device 110 may receive a response to analysis request 114 in application 112, which may include such data output in one or more UIs utilized to interact with and/or displayed by model analysis tool 133.

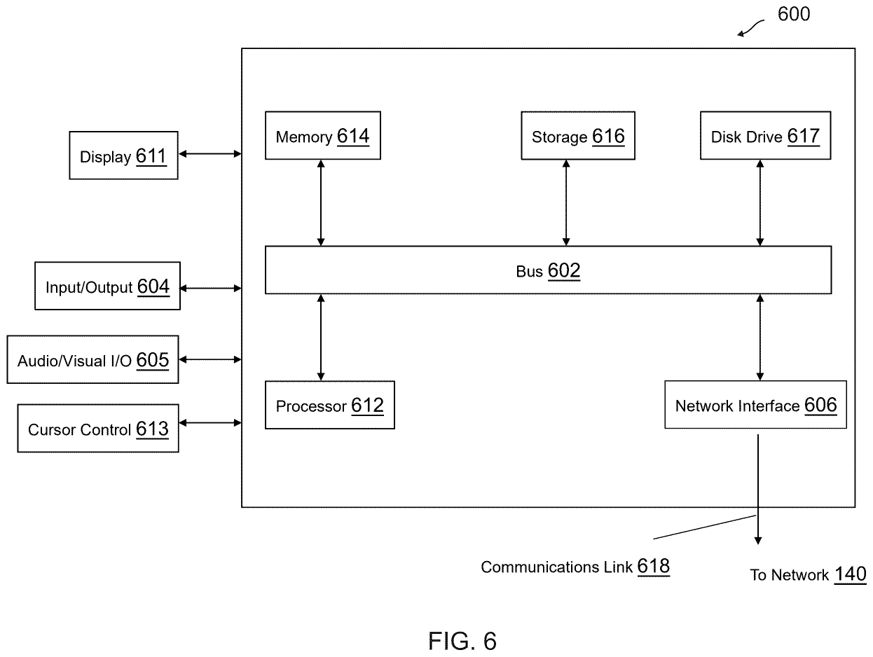

FIG. 6 is a block diagram of a computer system 600 suitable for implementing one or more components in FIG. 1A, according to an embodiment. In various embodiments, the communication device may comprise a personal computing device e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio/visual input/output component 605 may also be included to allow a user to use voice for inputting information by converting audio signals and/or use video to capture still or video images and provide video input. Audio I/O component 605 may allow the user to hear audio and/or view video. A transceiver or network interface 606 transmits and receives signals between computer system 600 and other devices, such as another communication device, service device, or a service provider server via network 140. In one embodiment, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In one embodiment, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PSTN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A system comprising:
a non-transitory memory; and
one or more hardware processors coupled to the non-transitory memory and configured to execute instructions to cause the system to:
receive, via a user interface (UI), a request for an analysis of a large language model (LLM);
processing an input sequence using a transformer model and one or more model configurations of the LLM when executed for the analysis;
determine a first time predicted for the LLM to process the input sequence based on the processing;
compute a decoding latency associated with decoding the processed input sequence based on the one or more model configurations;
determine a second time predicted for the LLM to generate output tokens based on the decoding latency;
calculate a first throughput parameter of the LLM associated with a token generation by the LLM based on the first time and the second time;
determine a model optimization of the LLM based on the first throughput parameter, the one or more model configurations, and available model configurations for the LLM; and
output, via the UI, the first throughput parameter and the model optimization of the LLM responsive to the request.

2. The system of claim 1, wherein the processing the input sequence is performed without producing any of the output tokens, wherein the processing the input sequence includes:
calculating initial hidden states of the transformer model using the one or more model configurations and based on the processing, and wherein the first time comprises a length of time utilized for the processing the input sequence and the calculating the initial hidden states.

3. The system of claim 1, wherein computing the decoding latency is further based on a number of bytes of memory access per a given bandwidth associated with the one or more model configurations, wherein the number of bytes of memory access is associated with a number of the output tokens.

4. The system of claim 1, wherein the first throughput parameter comprises a theoretical time for the LLM to generate at least one of the output tokens, and wherein outputting, via the UI, the first throughput parameter includes providing a comparison of the first throughput parameter to a real throughput parameter from a real-world deployment of the LLM in a production computing environment.

5. The system of claim 1, wherein outputting, via the UI, the first throughput parameter comprises causing the UI to be displayed on a computing device, wherein the UI comprises content that is associated with the first throughput parameter and the model optimization for the analysis of the LLM, wherein the UI includes an option to generate a report for the LLM, and wherein the report includes information for a model performance of the LLM that is associated with at least the first throughput parameter.

6. The system of claim 1, wherein the first throughput parameter comprises one of a response time to an input text or an input set of tokens, an error rate, or an inference speed, and wherein the one or more model configurations comprise at least one of an LLM architecture, a parameter size of parameters for the LLM, an LLM model size, a graphics processing unit (GPU) architecture of a GPU assigned to run the LLM, a computing power of a computing system assigned to run the LLM, or a compute unified device architecture (CUDA) memory available to the GPU assigned to run the LLM.

7. The system of claim 1, wherein executing the instructions further causes the system to:
provide, via the UI, one or more options to configure the one or more model configurations for testing the LLM on at least one of a plurality of hardware configurations, a plurality of model versions, or a plurality of model hyperparameters.

8. The system of claim 7, wherein the one or more options include an option to view a previous test of the LLM, and wherein executing the instructions further causes the system to:
receive a selection of the option; and
output the previous test with a comparison to the analysis based on the one or more model configurations.

9. The system of claim 7, wherein executing the instructions further causes the system to:
receive a change to the one or more model configurations via the one or more options; and
calculate a second throughput parameter based on at least on the change.

10. A method comprising:
receiving, via a user interface (UI), a request for an analysis of a performance metric a large language model (LLM), wherein the request includes an input sequence length, an output token length, and a number of concurrent requests to be handled by the LLM;
determining, based on the request, a processing unit specification for a processing unit designated to run the LLM;
determining, based on the input sequence length, a first time predicted for the LLM to process the analysis prior to generating an output token based on a transformer model, the processing unit specification, and the number of concurrent requests;
computing a decoding latency for decoding hidden state data to the output token length based on the processing unit specification;
determining a second time predicted for the LLM to generate the output token based on the decoding latency and the number of concurrent requests;
calculating the performance metric based at least on the first time and the second time;
determining if a change to the processing unit specification is capable of reducing the first time or the second time; and
outputting, via the UI, the performance metric and a recommendation associated with the determining if the change is capable of reducing the first time or the second time.

11. The method of claim 10, wherein the number of concurrent requests is associated with a concurrency of user requests to the LLM for a number of concurrent users each having at least one active request to the LLM.

12. The method of claim 10, wherein the determining the first time comprises:
processing the input sequence length by the transformer model; and
calculating a time for determining initial hidden states of the transformer model based on the processed input sequence length.

13. The method of claim 12, wherein the computing the decoding latency comprises:
calculating a time to decode the initial hidden states of the transformer model.

14. The method of claim 10, wherein the performance metric comprises a time-to-first-token (TTFT) that indicates an amount of time from receiving an input token of the input sequence length to outputting the output token.

15. The method of claim 14, wherein the TTFT is a theoretical time, and wherein the TTFT is output for a plurality of values of the number of concurrent requests.

16. The method of claim 10, further comprising:
receiving a real performance metric of the LLM from inferencing in a production computing environment; and
providing the performance metric with the real performance metric.

17. The method of claim 10, wherein the processing unit specification is associated with a graphics processing unit (GPU) and includes at least one hardware specification of the GPU.

18. The method of claim 10, further comprising:
receiving the change to the processing unit specification; and
recalculating the performance metric based on the change.

19. A non-transitory machine-readable medium having stored thereon machine-readable instructions executable to cause a machine to perform operations comprising:
identifying a machine learning (ML) model and an ML model configuration of the ML model for testing a throughput parameter of the ML model;
determining a first time for the ML model to process an input for an ML model inferencing of an output by the ML model, wherein the first time is determined based at least on the ML model configuration;
determining a second time for the ML model to perform the ML model inferencing of the output based on the input processed by the ML model and the ML model configuration;
calculating the throughput parameter of the ML model based at least on a total time for the ML model to generate the output;
computing at least one of an increase or a decrease to the throughput parameter based on a change to the model configuration for testing the throughput parameter;
generating analytical data for the ML model based on the throughput parameter and the computing, wherein the analytical data comprises information presentable via a user interface (UI); and
displaying, via the UI, the analytical data of the ML model.

20. The non-transitory machine-readable medium of claim 19, wherein the first time comprises a prefill time to process the input and calculate initial hidden states of a transformer model using the processed input, and wherein the second time comprises a decoding latency to decode the initial hidden states and generate an output.
